(19) United States
(12) Patent Application Publication
(10) Pub. No.: US 2024/0168787 A1
(43) Pub. Date: May 23, 2024

(54) SECURE LIVE MIGRATION OF TRUSTED EXECUTION ENVIRONMENT VIRTUAL MACHINES USING SMART CONTRACTS

(71) Applicant: Intel Corporation, Santa Clara, CA (US)

(72) Inventors: Vinothini Gunasekaran, Bangalore (IN); Santosh Deshpande, Bangalore (IN); Ajay Kishore, Bengaluru (IN)

(73) Assignee: Intel Corporation, Santa Clara, CA (US)

(21) Appl. No.: 17/992,141

(22) Filed: Nov. 22, 2022

(51) Int. Cl. G06F 9/455; G06Q 30/08

(52) U.S. Cl. CPC G06F 9/45558; G06Q 30/08; G06F 2009/4557; G06F 2009/45587

(57) ABSTRACT

The technology disclosed herein includes broadcasting, to a plurality of destination computing systems, a request to live migrate at least one trusted execution environment virtual machine (TVM) to at least one of the plurality of destination computing systems, receiving one or more bids from at least one of the plurality of destination computing systems, allocating the at least one TVM to at least one of the plurality of destination computing systems based at least on a bidding price in the one or more bids, automatically live migrating the at least one TVM to the at least one of the plurality of destination computing systems based on the allocating, and storing live migration allocation information of the at least one TVM on a first blockchain.

### FIELD OF THE DISCLOSURE

This disclosure relates generally to migration of processes in computing systems, and more particularly, to implementing secure live migration of trusted execution environment virtual machines running in computing systems using smart contracts.

### BACKGROUND

Some computing systems provide confidential computing architectures that include architectural elements to help deploy hardware-isolated, trusted execution environment (TEE) virtual machines (VMs) (TVMs). In some implementations, TVMs are called trusted domains (TDs). One example of such a confidential computing architecture is Intel® Trust Domain Extensions (Intel® TDX). TDX is designed to isolate TDs from a virtual machine manager (VMM)/hypervisor, and any other non-TD software on the computing system, to protect TDs from a broad range of potential software attacks.

In some computing environments, a confidential computing architecture, such as TDX, does not trust cloud service provider (CSP) software. CSP-managed software, which may include the VMM/hypervisor, host operating system (OS), basic input/output (I/O) system (BIOS), other applications not running in the TVM, and other potential adversaries (such as the computing infrastructure, network administrator and computer technician) are included in some of the threat models.

Currently, migrating a TVM from management by one VMM/hypervisor (e.g., a source) to another VMM/hypervisor (e.g., a destination) can be done in two ways. The first way, called cold migration, requires that applications running in the TVM on the source computing system are stopped and restarted on the destination computing system. The second way, called live migration, allows applications running in the TVM on the source computing system to migrate to the destination computing system based on the source computing system request, without getting disconnected from the present states of the applications. During live migration, the applications resume their activity on the destination computing systems but are not restarted. Currently, live migration can be performed only on a one-to-one basis (e.g., from a single source computing system to a single destination computing system).

Furthermore, existing approaches to live migration require manual steps to be taken by an orchestrator in a CSP to change a system configuration on the destination computing system to align with the characteristics of the source computing system (such as the state of the TVM to be migrated, application code parameters, application data parameters, etc.). This manual intervention by the network administrator is burdensome for CSPs.

### BRIEF DESCRIPTION OF THE DRAWINGS

FIG. 1 illustrates a computing arrangement that provides for secure live migration of TVMs using smart contracts according to an example.

FIG. 2 illustrates a computing system that provides for secure live migration of TVMs using smart contracts according to an example.

FIG. 3 illustrates a computing arrangement of a source computing system and a plurality of destination computing systems according to an example.

FIG. 4 illustrates secure live migration processing by a source computing system according to an example.

FIG. 5 illustrates secure live migration processing by a destination computing system according to an example.

FIG. 6 is a block diagram of an example processor platform structured to execute and/or instantiate the machine-readable instructions and/or operations of FIGS. 1-5 to implement the apparatus discussed with reference to FIGS. 1-5.

FIG. 7 is a block diagram of an example implementation of the processor circuitry of FIG. 6.

FIG. 8 is a block diagram of another example implementation of the processor circuitry of FIG. 6.

FIG. 9 is a block diagram illustrating an example software distribution platform to distribute software such as the example machine readable instructions of FIG. 6 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method, system and apparatus to provide secure live migration of trusted execution environment virtual machines (TVMs) in computing systems. The technology described herein provides the capability to automatically live migrate a TVM from a single source computing system to a plurality of destination computing systems without manual intervention by an orchestrator in a CSP computing environment.

Some implementations herein are described with respect to the confidential computing architecture of Intel® TDX, although other implementations may also be used in other confidential computing architectures including TVMs, such as AMD® Secure Encrypted Virtualization (SEV) or ARM® Realm Management Extension (RME), for example.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share the same name. As used herein, “approximately” and “about” refer to dimensions that may not be exact due to manufacturing tolerances and/or other real-world imperfections.

As used herein, “processor” or “processing device” or “processor circuitry” or “hardware resources” are defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). As used herein, a device may comprise processor circuitry or hardware resources.

As used herein, a computing system can be, for example, a server, a disaggregated server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an electronic voting machine, or any other type of computing device.

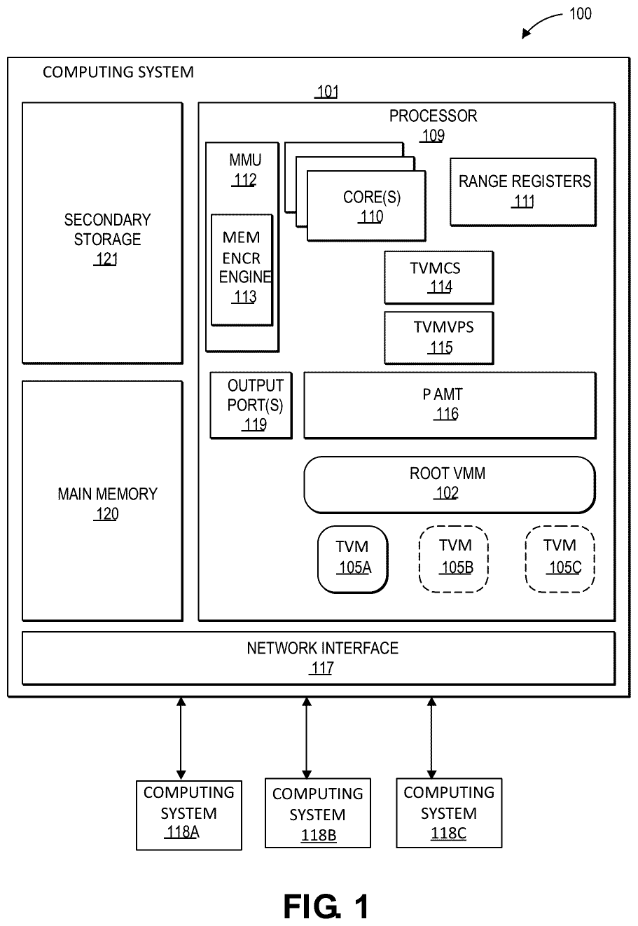

FIG. 1 is a schematic block diagram of a computing arrangement 100 that provides for isolation in virtualized systems using TVMs, according to an implementation of the disclosure.

In the following description, numerous specific details are set forth, such as specific application binary interface (ABI) primitives, specific operations and sequences of operations, specific Intel® Trust Domain Extensions (TDX) implementation details, and the like. However, embodiments may be practiced without these specific details. In other instances, well-known circuits, structures and techniques have not been shown in detail to avoid obscuring the understanding of the description.

CSPs, driven by their customers' requirements, desire cryptographic isolation for customer workloads running on their computing platforms. In some implementations, cryptographic isolation may be provided by Secure Memory Encryption (SME) and Secure Encrypted Virtualization (SEV) from AMD and ARM® Realm Management Extension (RME), for example, to meet these requirements for the cloud providers. In other implementations, cryptographic isolation may be provided by TDX from Intel® Corporation for providing such isolation on servers and removing CSP software (e.g., VMM, OS, etc.) from the trust boundary. TDX provides cryptographic isolation for customer workloads in a cloud computing environment using multi-key (MK) total memory encryption engine circuitry 113 (TME)(MKTME), which provides both confidentiality and integrity.

In some implementations, protected TVMs 105A, 105B, and 105C may be TDs in TDX. TDX extends Virtual Machines Extensions (VMX) and MKTME 113 with a virtual machine guest called a trust domain (TD). A TD runs in a central processing unit (CPU) mode which protects the confidentiality of the TD's memory contents and the TD's CPU state from any other software, including a VMM, unless explicitly shared by the TD itself. TDX is built on top of Secure Arbitration Mode (SEAM), which is a CPU mode and extension of the VMX instruction set architecture (ISA). The TDX module, running in SEAM mode, serves as an intermediary between a VMM (e.g., root VMM 102) and the guest TDs. In some implementations, TDX running in SEAM mode may be implemented as a trusted execution environment (TEE) security manager (TSM). The VMM is expected to be TDX-aware. The VMM can launch and manage both guest TDs and legacy guest VMs. The VMM may maintain legacy functionality from the legacy VMs perspective. The VMM may be restricted regarding the TDs managed by the VMM.

Generally, a TSM (such as a TDX module in a TDX architecture) may help to provide confidentiality (and integrity) for customer (tenant) software executing in an untrusted CSP computing infrastructure. The TVM architecture, which can be a System-on-Chip (SoC) capability, provides isolation between TVM workloads and CSP software, such as root VMM 102 of the computing system 101 managed by a CSP. Components of the TVM architecture may include 1) memory encryption (e.g., via a MKTME memory encryption engine circuitry 113), 2) a resource management capability such as a VMM, and 3) execution state and memory isolation capabilities in a processor of computing system hardware provided via a TSM managed Physical Address Metadata Table (PAMT) 116 and via TSM enforced confidential TVM control structures. The TVM architecture provides an ability of a processor to deploy TVMs that leverage a memory encryption engine (such as the MKTME engine), the PAMT 116, a Secure (integrity-protected) Extended Page Table (SEPT) and access-controlled confidential TVM control structures (TVMCS) 114 for secure operation of TVM workloads.

In one implementation, the tenant's software is executed in a TVM (e.g., a TD). This TVM (also referred to as a tenant TVM) refers to a tenant workload (which can comprise an OS alone along with other ring-3 applications running on top of the OS, or a VM running on top of VMM along with other ring-3 applications, for example). Each TVM 105A, 105B, and 105C may operate independently of other TVMs in the system and may use logical processor(s), memory, and I/O assigned by root VMM 102 on the platform. Each TVM may be cryptographically isolated in memory using at least one exclusive encryption key of the memory encryption engine (e.g., MKTME memory encryption engine circuitry 113) to encrypt the memory (holding code and/or data) associated with the TVM.

In some implementations, the root VMM 102 in the TVM architecture may act as a host for the TVMs and may have full control of the cores and other components of computing system 101 hardware. The VMM may assign software in a TVM with logical processor(s). The VMM, however, may be restricted from accessing the TVM's execution state on the assigned logical processor(s). Similarly, the VMM assigns physical memory and I/O resources to the TVMs but is not privy to access the memory state of a TVM due to the use of separate encryption keys enforced by the CPUs per TVM, and other integrity and replay controls on memory. Software executing in a TVM operates with reduced privileges so that the VMM can retain control of platform resources. However, the VMM cannot affect the confidentiality or integrity of the TVM state in memory or in the CPU structures under defined circumstances.

The computing system 101 supports and/or communicates with (e.g., client) computing systems 118A-118C. Computing system 101 includes at least one processor 109 (also referred to as a processing device) that executes a root VMM 102 (which may be an implementation of a VMM). The root VMM 102 that may instantiate one or more TVMs 105A-105C accessible by the client computing systems 118A-118C via a network interface 117. The client computing systems may include, but are not limited to, one or more of a desktop computer, a tablet computer, a laptop computer, a netbook, a notebook computer, a personal digital assistant (PDA), a server, a workstation, a cellular telephone, a mobile computing device, a smart phone, an Internet appliance, a server or any other type of computing device.

A TVM may refer to a tenant (e.g., customer) workload. The tenant workload can include an OS alone along with other ring-3 applications running on top of the OS or can include a VM running on top of a VMM along with other ring-3 applications, for example.

The processor 109 may include one or more cores 110, range registers 111, a memory management unit (MMU) 112, and output port(s) 119, one or more TVM control structure(s) (TVMCS(s)) 114 and TVM virtual-processor control structure(s) (TVMVPS(s)) 115. The processor 109 may be used in a system that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance, a server or any other type of computing device. In another implementation, the processor 109 may be used in a SoC system.

The computing system 101 may be a server or other computer system having one or more processors available from Intel Corporation, AMD, Inc., or other processor developer, although the scope of the technology described herein is not so limited. In one implementation, sample computing system 101 executes a version of the WINDOWS™ operating system available from Microsoft Corporation of Redmond, Washington, although other operating systems (UNIX and Linux for example), embedded software, and/or graphical user interfaces, may also be used. Thus, implementations of the disclosure are not limited to any specific combination of hardware circuitry and software.

The one or more processing cores 110 execute instructions of the system. The processing core 110 includes, but is not limited to, pre-fetch circuitry to fetch instructions, decode circuitry to decode the instructions, execution circuitry to execute instructions and the like. In an implementation, the computing system 101 includes a component, such as the processor 109 to employ execution units including circuitry to perform processes for processing data.

Computing system 101 includes a main memory 120 and a secondary storage 121 to store program binaries and OS driver events. Data in the secondary storage 121 may be stored in blocks referred to as pages, and each page may correspond to a set of physical memory addresses. The computing system 101 may employ virtual memory management in which applications run by the core(s) 110, such as the TVMs 105A-105C, use virtual memory addresses that are mapped to guest physical memory addresses, and guest physical memory addresses are mapped to host/system physical addresses by a MMU 112.

The core 110 may use the MMU 112 to load pages from the secondary storage 121 into the main memory 120 (which includes a volatile memory and/or a non-volatile memory) for faster access by software running on the processor 109 (e.g., on the core). When one of the TVMs 105A-105C attempts to access a virtual memory address that corresponds to a physical memory address of a page loaded into the main memory, the MMU returns the requested data. The core 110 may execute the VMM portion of root VMM 102 to translate guest physical addresses to host physical addresses of main memory and provide parameters for a protocol that allows the core to read, walk and interpret these mappings.

In one implementation, processor 109 implements a TVM architecture with ISA extensions such as SEAM. The TVM architecture and the trusted execution environment security manager (TSM) running in SEAM mode provide isolation between TVM workloads 105A-105C and CSP software (e.g., a CSP VMM (e.g., root VMM 102)) executing on the processor 109. Components of the TVM architecture can include 1) memory encryption, integrity protection and replay-protection via a memory encryption engine circuitry 113; 2) a resource management capability referred to herein as the root VMM 102; and 3) execution state and memory isolation capabilities in the processor 109 provided via a PAMT 116 and via access-controlled confidential TVM control structures (e.g., TVMCS 114 and TVMVPS 115). The TVM architecture provides an ability of the processor 109 to deploy TVMs 105A-105C that leverage the memory encryption engine circuitry 113, the PAMT 116, and the access-controlled TVM control structures (e.g., TVMCS 114 and TVMVPS 115) for secure operation of TVM workloads 105A-105C.

In implementations of the disclosure, the root VMM 102 acts as a host and has control of the cores 110 and other platform hardware. A VMM assigns software in a TVM 105A-105C with logical processor(s). The VMM, however, cannot access a TVM's execution state on the assigned logical processor(s). Similarly, a VMM assigns physical memory and I/O resources to the TVMs but is not privy to access the memory state of the TVMs due to separate encryption keys, and other integrity and replay controls on memory.

With respect to the separate encryption keys, the processor may utilize the memory encryption engine circuitry 113 to encrypt (and decrypt) memory used during execution. With total memory encryption (TME), any memory accesses by software executing on the core 110 can be encrypted in memory with an encryption key. In an implementation, MKTME is an enhancement to TME that allows use of multiple encryption keys that may be implemented in memory encryption engine circuitry 113. The processor 109 may utilize the memory encryption engine to cause different pages to be encrypted using different keys. The memory encryption engine circuitry 113 may be utilized in the TVM architecture described herein to support one or more encryption keys per each TVM 105A-105C to help achieve the cryptographic isolation between different CSP customer workloads. For example, when a memory encryption engine is used in the TVM architecture, the CPU enforces by default that TVM (all pages) are to be encrypted using a TVM-specific key. Furthermore, a TVM may further choose specific TVM pages to be plain text or encrypted using different ephemeral keys that are opaque to CSP software.

Each TVM 105A-105C is a software environment that supports a software stack (e.g., using virtual machine extensions (VMX)), operating systems, and/or application software (hosted by the OS). Each TVM may operate largely independently of other TVMs and use logical processor(s), memory, and I/O assigned by the VMM 102 on the platform. Software executing in a TVM operates with reduced privileges so that the VMM can retain control of platform resources; however, the VMM cannot affect the confidentiality or integrity of the TVM under defined circumstances.

Computing system 101 includes a main memory 120. Main memory includes a DRAM device, a static random-access memory (SRAM) device, flash memory device, or other memory device. Main memory stores instructions and/or data represented by data signals that are to be executed by the processor 109. The processor may be coupled to the main memory via a processing device bus. A system logic chip, such as a memory controller hub (MCH) may be coupled to the processing device bus and main memory. An MCH can provide a high bandwidth memory path to main memory for instruction and data storage and for storage of graphics commands, data and textures. The MCH can be used to direct data signals between the processor, main memory, and other components in the system and to bridge the data signals between processing device bus, memory, and system I/O, for example. The MCH may be coupled to memory through a memory interface. In some implementations, the system logic chip can provide a graphics port for coupling to a graphics controller through an Accelerated Graphics Port (AGP) interconnect.

Computing system 101 may also include an I/O controller hub (ICH). The ICH can provide direct connections to some I/O devices via a local I/O bus. The local I/O bus is a high-speed I/O bus for connecting peripherals to the memory 120, chipset, and processor 109. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

To eliminate the manual effort currently required in live migration of TVMs, in an embodiment a source computing system (such as computing system 101) and a destination computing system (such as one or more of computing systems 118A, 118B, 118C) may be coupled as part of an auction environment using blockchain technology. An automated auction may be used for destination computing systems to bid for allocation of TVMs to be migrated to the destination computing systems. For example, an embodiment may implement an Ethereum Classic process as described in “Blockchain 2.0: A Smart Contract” by Kavita Saini, et al., 2021 International Conference on Computational Performance Evaluation (ComPE), Dec. 1, 2021, pp. 524-528. The smart contract process is used to make the auction process immutable. In an embodiment, an Ethereum Classic process may be incorporated as a submodule with an existing TDX implementation. To prepare the source computing system and one or more destination computing systems for the auction process, all parties must broadcast their respective configuration information to the blockchain process, since the blockchain process is the decision maker for the automated live migration of TVMs. As part of the broadcasting process step, the source computing system and the one or more destination computing systems provide their system configuration information, such as CPU state, memory size, trusted computing base (TCB) capabilities, making the bidding process more secure and effective. In an embodiment, every TVM migration is accounted for as a potential revenue generation activity based on a currency value signed by the source computing system and the one or more destination computing systems as part of the auction process.

An advantage of the technology described herein is that this technology enables a CSP (e.g., operating one or more of the source computing system and one or more destination computing systems) to support secure live migration of TVMs from one source computing system to many destination computing systems without any intervention or manual effort by a human cloud orchestrator. In an implementation, a processor (e.g., processor 109) includes additions to the ISA for confidential computing architecture instructions responsible for live migration of TVMs.

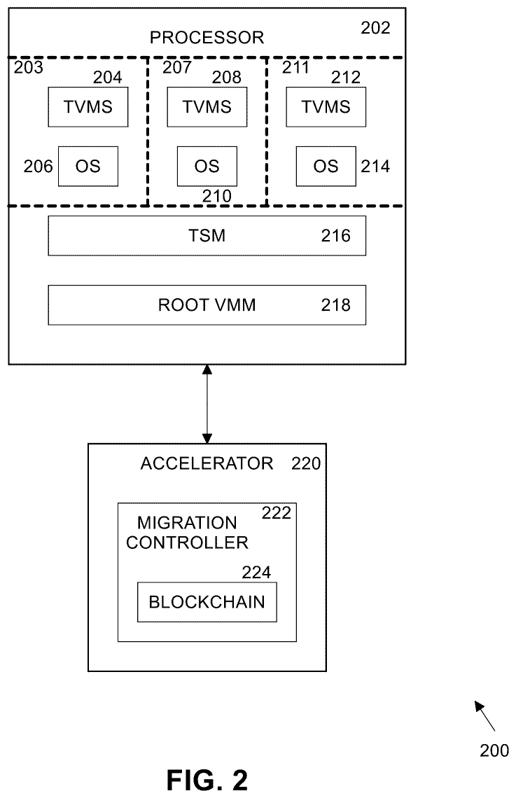

FIG. 2 illustrates a computing system that provides secure live migration of TVMs using smart contracts according to an example. In an example, computing system 200 is an instance of computing system 101 and/or computing systems 118A, 118B, 118C of FIG. 1, with some components omitted for clarity. Processor 202 of computing system 200 includes root VMM 218 to manage VMs and TSM 216 to provide security for a plurality of isolated computing environments 203, 207, and 211. Each isolated computing environment includes one or more TVMs and an OS. For example, isolated computing environment 203 includes TVMs 204 and OS 206, isolated computing environment 207 includes TVMs 208 and OS 210, and isolated computing environment 211 includes TVMs 212 and OS 214. Computing system 200 includes migration controller 222 to manage the auction process and secure automatic live migration of TVMs. Migration controller 222 uses blockchain 224 to store results of the auction process and information describing live migrated TVMs. In one implementation, migration controller 222 is implemented in accelerator 220, including circuitry to implement secure live migration of TVMs in such a manner that is faster than by implementing secure live migration of TVMs in instructions executed by processor 202. In another implementation, migration controller 222 is implemented in processor 202, either by software instructions or hardware circuitry.

Table 1 illustrates features of a blockchain, such as Ethereum Classic, and how the features are used in implementations described herein.

TABLE 1

| | Blockchain | |
|---|---|---|
| Feature | process | Use |
| Crypto- | Yes | To ensure the live migrations are genuine |
| currency | (Proof of | (e.g., TVM transaction flow from an |
| | activity) | authentic source to an attested (verified) |
| | | destination). |
| Smart | Yes | Used to automate the live migration flow |
| Contracts | | when conditions are met by the source |
| | | and destinations to be part of the |
| | | auction agreement system. |
| Consensus | Yes | Based on the agreement signed up by |
| Mechanism | (Proof of | the source (seller) and the destination |
| | work) | (buyer) for auction; consensus mechanism |
| | | used to validate the live migration |
| | | process against the agreement's terms |
| | | and conditions. |
| Monetary | Fixed | This stabilizes the price during the auction |
| Policy | | for both parties (seller and buyer). |
| Database | Replicated | The TVM migration information is merged |
| | | and stored as an entry into the ledger. |
| High | Yes | Centralized auction system with the ledger |
| Security | | information; the attestation process and |
| | | the auction process are immutable. |

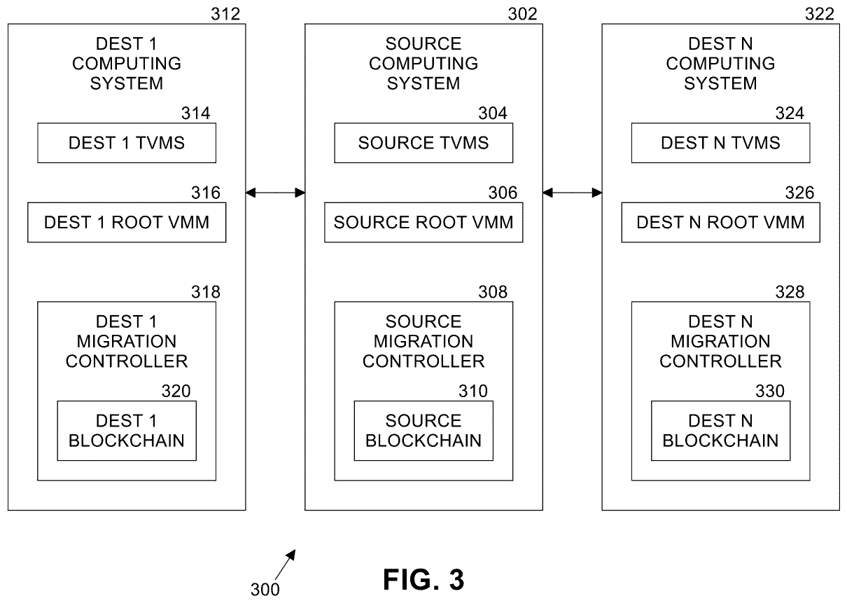

FIG. 3 illustrates a computing arrangement 300 of a source computing system and a plurality of destination computing systems according to an example. Source computing system 302 includes a plurality of source TVMS 304 and a source root VMM 306. In a scenario, at least one of the source TVMs 304 is to be live migrated to a selected destination computing system. Source computing system 302 includes source migration controller 308 to manage a process of live migrating the at least one of the source TVMs 304. Source migration controller 308 includes source blockchain 310. Source computing system 302 is an instance of computing system 200. Computing arrangement 300 includes a plurality of destination computing systems, such as destination 1 (dest 1) computing system 312 and destination N (dest N) computing system 322, where N is a natural number. In an implementation, source computing system 302 and destination computing systems 312, 322 are operated by a CSP. In one example, there may be one source computing system 302 and any number of destination computing systems 312 . . . 322 (e.g., tens, hundreds, thousands, tens of thousands, etc.). Destination computing systems may also be instances of computing system 200. Each destination computing system includes a plurality of destination TVMs, a destination root VMM, and a destination migration controller managing a destination blockchain. For example, destination 1 computing system 312 includes destination 1 TVMs 314, destination 1 root VMM 316, destination 1 migration controller 318 and destination 1 blockchain 320, and destination N computing system 322 includes destination N TVMs 324, destination N root VMM 326, destination N migration controller 328 and destination N blockchain 330. Blockchains implemented in source computing system 302 (e.g., source blockchain 310) can communicate with blockchains implemented in destination computing systems (e.g., dest 1 blockchain 320 . . . dest N blockchain 330) in a standardized way (e.g., using a cross-chain protocol). In any scenario, any one of the computing systems shown in FIG. 3 may operate as a source computing system at any point in time and any one or more of the computing systems shown may operate as a destination computing system. This allows for any TVM running on any computing system to be live migrated to any other computing system in computing arrangement 300.

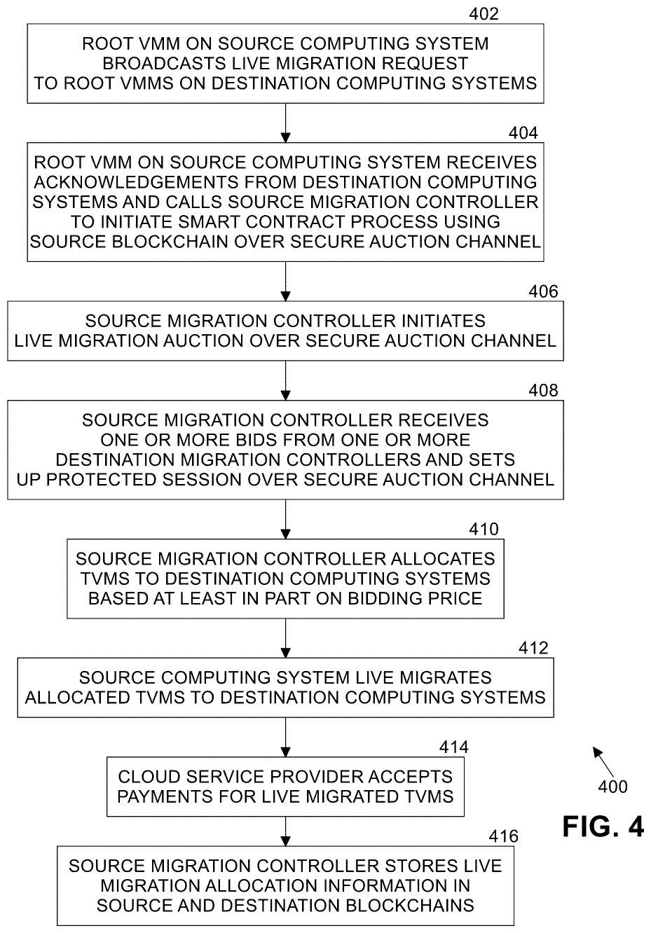

FIG. 4 illustrates secure live migration processing 400 by a source computing system 302 according to an example. At block 402, when source computing system 302 determines that one or more source TVMs 304 need to be live migrated, source root VMM 306 of source computing system 302 broadcasts a live migration request to destination root VMMs 316, 326 on the destination computing systems 312, 322 over any suitable communications mechanism. The live migration request includes characteristics of TVMs such as state of the TVM, application code details and/or parameters, TVM data, etc., and also source computing system configuration information such as number of TVMs to be live migrated.

The CSP migrates a TVM only to destinations platforms that meet the necessary trusted computing base (TCB) requirements and platform compatibility requirements in a TVM migration policy. In an implementation, the TVM migration policy is configurable, per TVM, and attestable. Confidentiality, integrity and replay protection of TVM assets being migrated is agnostic of the transport mechanisms used by the CSP between the source computing system and the destination computing system. TVM migration enforces resetting non-migratable assets (such as any state and/or data that can be serialized and recreated on the destination computing system) on the source computing system and restoring the assets on the destination computing system after migration. In an example, such resetting and restoring may be performed for mem0ry mapping configuration.

In an implementation, once the live migration is initiated by sending the live migration request, the TSM of the source computing system 302 makes a SEAM call to invoke a blockchain API. In a TDX implementation, this includes a call to the blockchain API in a TDX driver. The SEAM call includes configuration information from the live migration request. In an embodiment, a new instruction is added to the processor ISA to initiate the live migration.

At block 404, source root VMM 306 on source computing system 302 receives acknowledgements from destination computing systems 312, 322 and calls source migration controller 308 to initiate a smart contract process using source blockchain 310 over a secure auction channel. An acknowledgement is an indication that a destination computing system will make a bid in the live migration auction for the destination computing system to accept a number of TVMs from the source computing system.

At block 406, source migration controller 308 initiates the live migration automated auction over a secure auction channel. In an implementation, source root VMM 306 requests source migration controller 308 in an accelerator (e.g., accelerator 220) to perform a smart contract process (e.g., Ethereum Classic process) based at least in part on the bids received from the destination computing systems. The smart contract process makes the live migration process look like an automated auction process. To support automation of the live migration auction, information from source computing system, such the number of TVMs to be migrated, TCB capability, current workload, and premium allocation are used by the smart contract process. The smart contract process also needs the number of participating destinations computing systems once the destination computing systems are compatible with the source computing system.

Once the smart contract process (e.g., Ethereum Classic process) is active, the live migration auction is initiated by 1) verifying the buyer/seller ecosystem (e.g., source and destination computing systems arrangement 300) with an elliptic curve Diffie-Hellman (ECDH) key exchange; 2) the source computing system and the destination computing systems agree to be part of the auction system by consensus mechanism; 3) the agreement includes information such as how many TVMs does each buyer want to request in the auction, what is the price (e.g., currency value) quoted by each buyer for the auction, and how many TVMs are ready to be live migrated from the source computing system; and 4) determining present states of destination root VMMs and number of TVMs currently running in the destination computing systems (e.g., current workloads). The source migration controller submits the details about the number of TVM's, data to be migrated and a migration key visible only to the smart contract process.

In an implementation, streams of migration of TVMs are set up for concurrent export and import of TVM data. Each migration stream is cryptographically encrypted via advanced encryption standard (AES) Galois counter mode (GCM) and ciphertext is generated using a unique initialization vector (IV). A communications channel to convey the migration streams of TVM data between source computing system 302 and destination computing systems 312 . . . 322 is established as a secure channel using an ECDH process. In an implementation, metadata containing a migration key and broadcast information may be included in the same encrypted channel for the live migration auction.

At block 408, source migration controller 308 receives one or more bids from one or more destination computing systems 312, 322 and sets up a protected session for the live migration auction over the secure auction channel. In an implementation, source computing system 302 generates a source (public, private) key pair and destination (public, private) key pairs (one key pair per destination computing system). By exchanging public keys, both the source computing system and the destination computing systems generate its own shared key. Each buyer (e.g., destination computing system) submits their verification key (referred as the public key in the above context) to the smart contract process in source migration controller 308 along with the bidding value for each TVM that the buyer would like to have allocated. This ensures that when the buyer wins the bidding, the buyer receives the encrypted data present in the live migration secure auction channel along with a key to decrypt the data at the destination computing system. Authentic live migration is ensured through the use of proof of activity and proof of work aspects of the smart contract process.

At block 410, source migration controller 308 (e.g., the seller in the auction) allocates TVMs to destination computing systems 312, 322 (e.g., buyers in the auction) based on at least bidding price. In an implementation, the monetary policy feature as of Ethereum Classic fixes the bidding price across the source computing system and the destination computing systems for the live migration auction. All the TVM's workload information from the destination computing systems 312 . . . 322 are replicated to the source migration controller 308 as part of the information broadcast at block 402.

At block 412, source computing system 302 automatically live migrates allocated TVMs, in an immutable manner, to a plurality of destination computing systems according to the bids. In an implementation, the TVMs are live migrated automatically, without intervention by an orchestrator on the CSP. In one implementation, at block 414, a CSP (such as the CSP operating one or more of source computing system 302 and/or destination computing systems 312 . . . 322 accepts payments for the live migrated TVMs from the destination computing systems that accepted migrated TVMs. At block 416, source migration controller 308 creates entries about all the migrated TVMs as part of the live migration auction. This information is merged and replicated in source blockchain 310 and destination block chains 320 . . . 330 as part of the smart contract process (such as provided by an Ethereum Classic database, which is commonly referred to as a ledger entry in source blockchain 310.

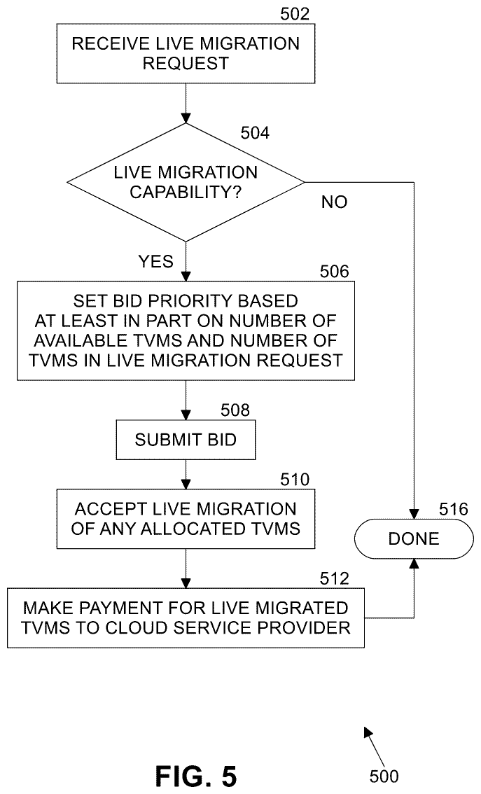

FIG. 5 illustrates secure live migration processing 500 by a destination computing system according to an example. At block 502, a destination computing system (e.g., one of destination 1 computing system 312 . . . destination N computing system 322) receives a live migration request from source computing system 302. If the destination computing system does not support a live migration capability at block 504, then processing is done at block 516. If the destination computing system does support a live migration capability at block 504, then at block 506, the destination migration controller (e.g., one of destination 1 migration controller 318 . . . destination N migration controller 328) of the destination computing system sets a bid priority for a bid to receive TVMs based at least in part on a current capacity to support a number of available TVMs by the destination computing system and a number of TVMs in the live migration request. For example, if the destination computing system can support an additional 10 TVMs and the live migration request includes 30 TVMs, then the destination computing system may bid for 10 TVMs to be migrated. In another example, if the destination computing system can support an additional 10 TVMs but the live migration request only includes 5 TVMs, then the destination computing system may bid for 5 TVMs. At block 508, the destination computing system submits the bid in response to the live migration request. If the destination computing system wins a bid (as determined by source migration controller 308 at block 410 of FIG. 4), then at block 510 the destination computing system accepts the live migration of any allocated TVMs. In an implementation, live migration may be performed as described in “Trust Domain Extension (TDX) Migration TD Design Guide,” by Intel Corporation, October 2021. In an embodiment, at block 512 the destination computing system makes payment for the live migrated TVMs to a CSP. Once the TVMs gets migrated to the destination computing systems 312 . . . 322, the TVMs use their migration keys, which are part of the migrating channel's metadata. Once the destination computing systems 312 . . . 322 are successful in importing the encrypted TVMs, destination computing systems use their migration keys to decrypt the TVM's data. In this implementation, the migrated TVMs will resume executing on top of the TSMs and destination root VMMs 316 . . . 326. Processing is then complete at block 516.

Although described herein with respect to TDX, the technology described herein may also be implemented in other confidential computing architectures such as AMD SEV, ARM RME, and/or ARM Confidential Computing Architecture (CCA).

While an example manner of implementing the technology described herein is illustrated in FIGS. 1-5, one or more of the elements, processes, and/or devices illustrated in FIGS. 1-5 may be combined, divided, re-arranged, omitted, eliminated, and/or implemented in any other way. Further, the example improved computing system 200 may be implemented by hardware, software, firmware, and/or any combination of hardware, software, and/or firmware. Thus, for example, any portion or all of the improved computing system 200 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example embodiments of FIGS. 1-5 may include one or more elements, processes, and/or devices in addition to, or instead of, those illustrated in FIGS. 1-5, and/or may include more than one of any or all the illustrated elements, processes and devices.

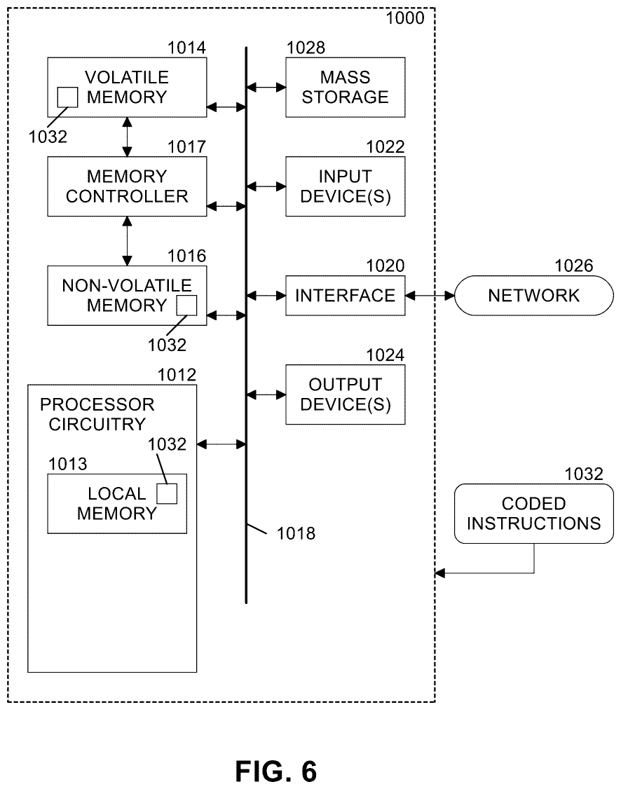

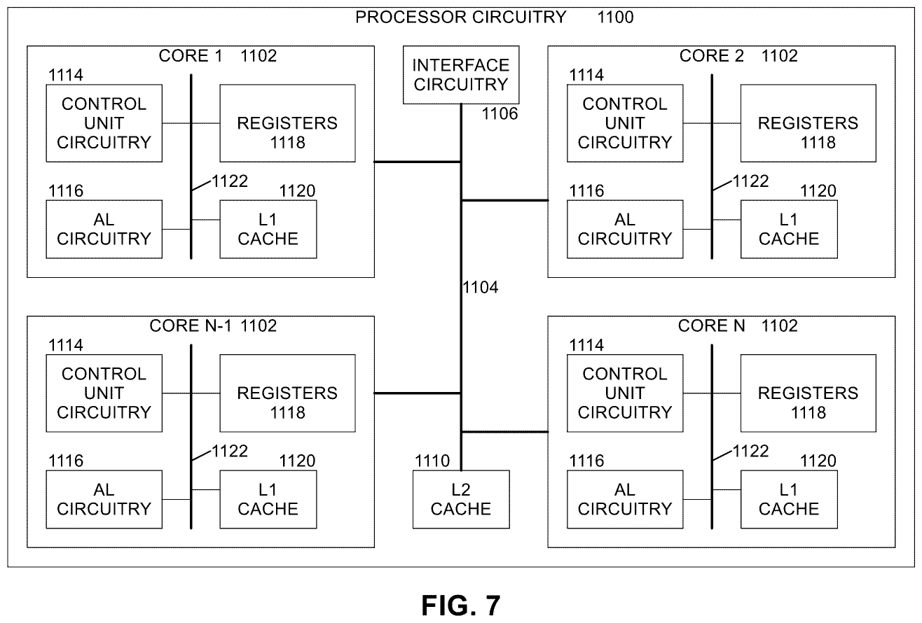

Flowcharts representative of example hardware logic circuitry, machine readable instructions, hardware implemented state machines, and/or any combination thereof is shown in FIGS. 4 and 5. The machine readable instructions may be one or more executable programs or portion(s) of an executable program for execution by processor circuitry, such as the processor circuitry 1012 shown in the example processor platform 1000 discussed below in connection with FIG. 6 and/or the example processor circuitry discussed below in connection with FIGS. 7 and/or 8. The program may be embodied in software stored on one or more non-transitory computer readable storage media such as a compact disc (CD), a floppy disk, a hard disk drive (HDD), a digital versatile disc (DVD), a Blu-ray disk, a volatile memory (e.g., random-access memory (RAM) of any type, etc.), or a non-volatile memory (e.g., flash memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4 and 5, many other methods of implementing the example computing system may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a block diagram of an example processor platform 1000 structured to execute and/or instantiate the machine-readable instructions and/or operations of FIGS. 1-5. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example processor circuitry 122.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 1-5, may be stored in the mass storage device 1028, in the volatile memory 1014, in the non-volatile memory 1016, and/or on a removable non-transitory computer readable storage medium such as a CD or DVD.

FIG. 7 is a block diagram of an example implementation of the processor circuitry 1012 of FIG. 6. In this example, the processor circuitry 1012 of FIG. 7 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowcharts of FIGS. 4 and 5.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 7. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

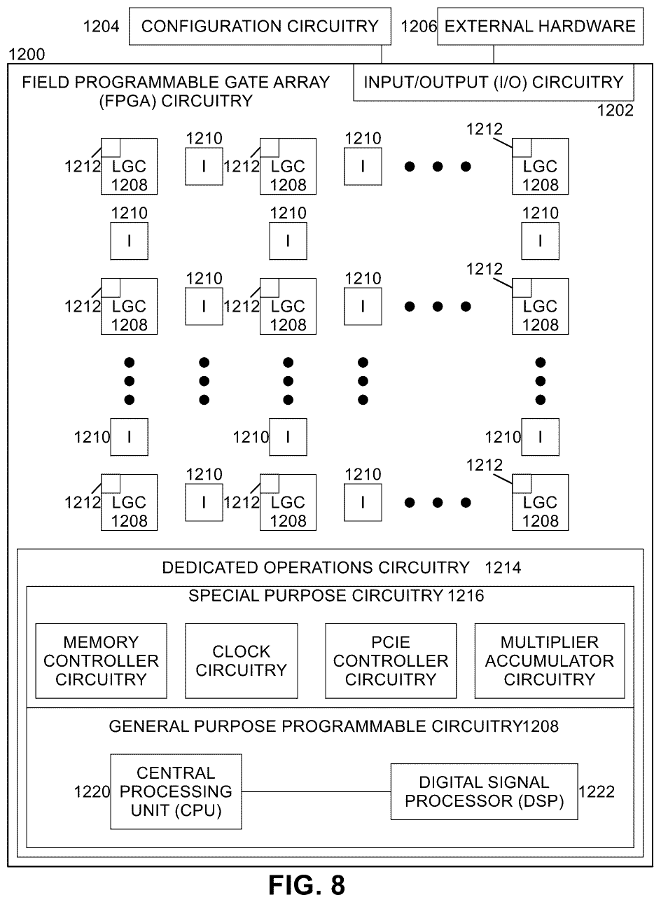

FIG. 8 is a block diagram of another example implementation of the processor circuitry 1012 of FIG. 6. In this example, the processor circuitry 1012 is implemented by FPGA circuitry 1200. The FPGA circuitry 1200 can be used, for example, to perform operations that could otherwise be performed by the example microprocessor 1100 of FIG. 7 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 7 described above (which is a general purpose device that may be programmed to execute some or all of the machine readable instructions represented by the flowcharts of FIGS. 4 and 5 but whose interconnections and logic circuitry are fixed once fabricated), the FPGA circuitry 1200 of the example of FIG. 8 includes interconnections and logic circuitry that may be configured and/or interconnected in different ways after fabrication to instantiate, for example, some or all of the machine readable instructions represented by the flowcharts of FIGS. 4 and 5. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 4 and 5. As such, the FPGA circuitry 1200 may be structured to effectively instantiate some or all the machine-readable instructions of the flowcharts of FIGS. 4 and 5 as dedicated logic circuits to perform the operations corresponding to those software instructions in a dedicated manner analogous to an ASIC. Therefore, the FPGA circuitry 1200 may perform the operations corresponding to the some or all the machine-readable instructions of FIGS. 4 and 5 faster than the general-purpose microprocessor can execute the same.

In the example of FIG. 8, the FPGA circuitry 1200 is structured to be programmed (and/or reprogrammed one or more times) by an end user by a hardware description language (HDL) such as Verilog. The FPGA circuitry 1200 of FIG. 8, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 7. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIGS. 4 and 5 and/or other desired operations. The logic gate circuitry 1208 shown in FIG. 8 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 8 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 7 and 8 illustrate two example implementations of the processor circuitry 1012 of FIG. 6, many other approaches are contemplated. For example, as mentioned above, modern FPGA circuitry may include an on-board CPU, such as one or more of the example CPU 1220 of FIG. 8. Therefore, the processor circuitry 1012 of FIG. 6 may additionally be implemented by combining the example microprocessor 1100 of FIG. 7 and the example FPGA circuitry 1200 of FIG. 8. In some such hybrid examples, a first portion of the machine-readable instructions represented by the flowcharts of FIGS. 4 and 5 may be executed by one or more of the cores 1102 of FIG. 7 and a second portion of the machine-readable instructions represented by the flowcharts of FIGS. 4 and 5 may be executed by the FPGA circuitry 1200 of FIG. 8.

In some examples, the processor circuitry 1012 of FIG. 6 may be in one or more packages. For example, the microprocessor 1100 of FIG. 7 and/or the FPGA circuitry 1200 of FIG. 8 may be in one or more packages. In some examples, an XPU may be implemented by the processor circuitry 1012 of FIG. 6, which may be in one or more packages. For example, the XPU may include a CPU in one package, a DSP in another package, a GPU in yet another package, and an FPGA in still yet another package.

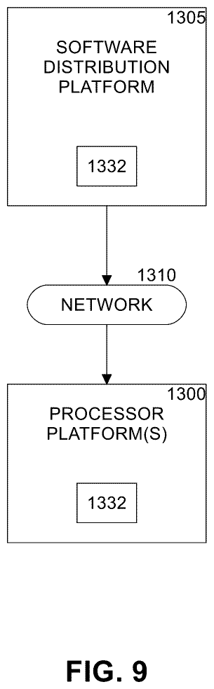

A block diagram illustrating an example software distribution platform 1305 to distribute software such as the example machine readable instructions 1032 of FIG. 6 to hardware devices owned and/or operated by third parties is illustrated in FIG. 9. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 6. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 101. In some examples, one or more servers of the software distribution platform 1305 periodically offer, transmit, and/or force updates to the software (e.g., the example machine readable instructions 1032 of FIG. 6) to ensure improvements, patches, updates, etc., are distributed and applied to the software at the end user devices.

In some examples, an apparatus includes means for data processing of FIGS. 1-5. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 6, the example microprocessor 1100 of FIG. 7, and/or the example Field Programmable Gate Array (FPGA) circuitry 1200 of FIG. 8. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a GPU, a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide improved performance for security in a computing system. The disclosed systems, methods, apparatus, and articles of manufacture improve the performance of implementing live migration of TVMs in computing systems. Thus, the disclosed systems, methods, apparatus, and articles of manufacture are accordingly directed to one or more improvement(s) in the operation of a machine such as a computer or other electronic and/or mechanical device.

The following examples pertain to further embodiments. Specifics in the examples may be used anywhere in one or more embodiments. Example 1 is a computing system including a memory to store a first blockchain; and migration controller circuitry coupled to the memory to broadcast, to a plurality of destination computing systems, a request to live migrate at least one trusted execution environment virtual machine (TVM) to at least one of the plurality of destination computing systems; receive one or more bids from at least one of the plurality of destination computing systems; allocate at least one TVM to at least one of the plurality of destination computing systems based at least on a bidding price in the one or more bids; automatically live migrate at least one TVM to at least one of the plurality of destination computing systems in response to an allocation; and store live migration allocation information of at least one TVM on the first blockchain.

In Example 2, the subject matter of Example 1 optionally includes wherein the request is broadcast from a root virtual machine manager (VMM) on the computing system to root VMMs on the plurality of destination computing systems. In Example 3, the subject matter of Example 1 optionally includes the migration controller circuitry to receive acknowledgements from the plurality of destination computing systems and initiate a smart contract process over a secure auction channel between the computing system and the plurality of destination computing systems sending the acknowledgements. In Example 4, the subject matter of Example 1 optionally includes the migration controller circuitry to initiate a live migration automated auction for the request over a secure auction channel. In Example 5, the subject matter of Example 4 optionally includes the migration controller circuitry to set up a protected session over the secure auction channel between the computing system and at least one of the plurality of destination computing systems sending bids. In Example 6, the subject matter of Example 1 optionally includes wherein at least one of the plurality of destination computing systems stores the live migration allocation information of at least one TVM on a blockchain on the at least one of the plurality of destination computing systems. In Example 7, the subject matter of Example 1 optionally includes wherein the one or more bids is based at least in part on a current capacity for processing a number of TVMs on at least one of the plurality of destination computing systems. In Example 8, the subject matter of Example 1 optionally includes accelerator circuitry including the migration controller circuitry.

Example 9 is a method including broadcasting, to a plurality of destination computing systems, a request to live migrate at least one trusted execution environment virtual machine (TVM) to at least one of the plurality of destination computing systems; receiving one or more bids from at least one of the plurality of destination computing systems; allocating at least one TVM to at least one of the plurality of destination computing systems based at least on a bidding price in the one or more bids; automatically live migrating at least one TVM to at least one of the plurality of destination computing systems in response to an allocation; and storing live migration allocation information of at least one TVM on a first blockchain.

In Example 10, the subject matter of Example 9 optionally includes broadcasting the request from a root virtual machine manager (VMM) on a source computing system to root VMMs on the plurality of destination computing systems. In Example 11, the subject matter of Example 9 optionally includes receiving acknowledgements from the plurality of destination computing systems and initiating a smart contract process over a secure auction channel between a source computing system and the plurality of destination computing systems sending the acknowledgements. In Example 12, the subject matter of Example 9 optionally includes initiating a live migration automated auction for the request over a secure auction channel. In Example 13, the subject matter of Example 12 optionally includes setting up a protected session over the secure auction channel between a source computing system and at least one of the plurality of destination computing systems sending bids. In Example 14, the subject matter of Example 9 optionally includes wherein at least one of the plurality of destination computing systems stores the live migration allocation information of at least one TVM on a blockchain on at least one of the plurality of destination computing systems. In Example 15, the subject matter of Example 9 optionally includes wherein the one or more bids is based at least in part on a current capacity for processing a number of TVMs on at least one of the plurality of destination computing systems.

Example 16 is at least one machine-readable storage medium comprising instructions which, when executed by at least one processor, cause the at least one processor to broadcast, to a plurality of destination computing systems, a request to live migrate at least one trusted execution environment virtual machine (TVM) to at least one of the plurality of destination computing systems; receive one or more bids from at least one of the plurality of destination computing systems; allocate at least one TVM to at least one of the plurality of destination computing systems based at least on a bidding price in the one or more bids; automatically live migrate at least one TVM to at least one of the plurality of destination computing systems in response to an allocation; and store live migration allocation information of at least one TVM on a first blockchain.

In Example 17, the subject matter of Example 16 optionally includes instructions which, when executed by at least one processor, cause the at least one processor to broadcast the request from a root virtual machine manager (VMM) on a source computing system to root VMMs on the plurality of destination computing systems. In Example 18, the subject matter of Example 6 optionally includes instructions which, when executed by at least one processor, cause at least one processor to receive acknowledgements from the plurality of destination computing systems and initiate a smart contract process over a secure auction channel between a source computing system and the plurality of destination computing systems sending the acknowledgements. In Example 19, the subject matter of Example 16 optionally includes instructions which, when executed by at least one processor, cause at least one processor to initiate a live migration automated auction for the request over a secure auction channel. In Example 20, the subject matter of Example 16 optionally includes instructions which, when executed by at least one processor, cause at least one processor to set up a protected session over the secure auction channel between a source computing system and at least one of the plurality of destination computing systems sending bids.

Example 21 is an apparatus operative to perform the method of any one of Examples 10 to 15. Example 22 is an apparatus that includes means for performing the method of any one of Examples 10 to 15. Example 23 is an apparatus that includes any combination of modules and/or units and/or logic and/or circuitry and/or means operative to perform the method of any one of Examples 10 to 15. Example 24 is an optionally non-transitory and/or tangible machine-readable medium, which optionally stores or otherwise provides instructions that if and/or when executed by a computer system or other machine are operative to cause the machine to perform the method of any one of Examples 10 to 15.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. A computing system comprising:
a memory to store a first blockchain; and
migration controller circuitry coupled to the memory to:
broadcast, to a plurality of destination computing systems, a request to live migrate at least one trusted execution environment virtual machine (TVM) to at least one of the plurality of destination computing systems;
receive one or more bids from at least one of the plurality of destination computing systems;
allocate at least one TVM to at least one of the plurality of destination computing systems based at least on a bidding price in the one or more bids;
automatically live migrate at least one TVM to at least one of the plurality of destination computing systems in response to an allocation; and
store live migration allocation information of at least one TVM on the first blockchain.

2. The computing system of claim 1, wherein the request is broadcast from a root virtual machine manager (VMM) on the computing system to root VMMs on the plurality of destination computing systems.

3. The computing system of claim 1, comprising the migration controller circuitry to receive acknowledgements from the plurality of destination computing systems and initiate a smart contract process over a secure auction channel between the computing system and the plurality of destination computing systems sending the acknowledgements.

4. The computing system of claim 1, comprising the migration controller circuitry to initiate a live migration automated auction for the request over a secure auction channel.

5. The computing system of claim 4, comprising the migration controller circuitry to set up a protected session over the secure auction channel between the computing system and at least one of the plurality of destination computing systems sending bids.

6. The computing system of claim 1, wherein at least one of the plurality of destination computing systems stores the live migration allocation information of at least one TVM on a blockchain on the at least one of the plurality of destination computing systems.

7. The computing system of claim 1, wherein the one or more bids is based at least in part on a current capacity for processing a number of TVMs on at least one of the plurality of destination computing systems.

8. The computing system of claim 1, comprising accelerator circuitry including the migration controller circuitry.

9. A method comprising:
broadcasting, to a plurality of destination computing systems, a request to live migrate at least one trusted execution environment virtual machine (TVM) to at least one of the plurality of destination computing systems;
receiving one or more bids from at least one of the plurality of destination computing systems;
allocating at least one TVM to at least one of the plurality of destination computing systems based at least on a bidding price in the one or more bids;
automatically live migrating at least one TVM to at least one of the plurality of destination computing systems in response to an allocation; and
storing live migration allocation information of at least one TVM on a first blockchain.

10. The method of claim 9, comprising broadcasting the request from a root virtual machine manager (VMM) on a source computing system to root VMMs on the plurality of destination computing systems.

11. The method of claim 9, comprising receiving acknowledgements from the plurality of destination computing systems and initiating a smart contract process over a secure auction channel between a source computing system and the plurality of destination computing systems sending the acknowledgements.

12. The method of claim 9, comprising initiating a live migration automated auction for the request over a secure auction channel.

13. The method of claim 12, comprising setting up a protected session over the secure auction channel between a source computing system and at least one of the plurality of destination computing systems sending bids.

14. The method of claim 9, wherein at least one of the plurality of destination computing systems stores the live migration allocation information of at least one TVM on a blockchain on at least one of the plurality of destination computing systems.

15. The method of claim 9, wherein the one or more bids is based at least in part on a current capacity for processing a number of TVMs on at least one of the plurality of destination computing systems.

16. At least one machine-readable storage medium comprising instructions which, when executed by at least one processor, cause the at least one processor to:
broadcast, to a plurality of destination computing systems, a request to live migrate at least one trusted execution environment virtual machine (TVM) to at least one of the plurality of destination computing systems;
receive one or more bids from at least one of the plurality of destination computing systems;
allocate at least one TVM to at least one of the plurality of destination computing systems based at least on a bidding price in the one or more bids;
automatically live migrate at least one TVM to at least one of the plurality of destination computing systems in response to an allocation; and
store live migration allocation information of at least one TVM on a first blockchain.

17. The at least one machine-readable storage medium of claim 16, comprising instructions which, when executed by at least one processor, cause the at least one processor to broadcast the request from a root virtual machine manager (VMM) on a source computing system to root VMMs on the plurality of destination computing systems.

18. The at least one machine-readable storage medium of claim 16, comprising instructions which, when executed by at least one processor, cause at least one processor to receive acknowledgements from the plurality of destination computing systems and initiate a smart contract process over a secure auction channel between a source computing system and the plurality of destination computing systems sending the acknowledgements.

19. The at least one machine-readable storage medium of claim 16, comprising instructions which, when executed by at least one processor, cause at least one processor to initiate a live migration automated auction for the request over a secure auction channel.

20. The at least one machine-readable storage medium of claim 19, comprising instructions which, when executed by at least one processor, cause at least one processor to set up a protected session over the secure auction channel between a source computing system and at least one of the plurality of destination computing systems sending bids.
